(19) United States
(12) Patent Application Publication
(10) Pub. No.: US 2026/0043698 A1
(43) Pub. Date: Feb. 12, 2026

(54) Device for Monitoring

(71) Applicant: Nippon Telegraph and Telephone Corporation, Tokyo (JP)

(72) Inventors: Kiyofumi Kikuchi, Musashino-shi, Tokyo (JP); Yuriko Kawamura, Musashino-shi, Tokyo (JP); Yuichiro Ikuma, Musashino-shi, Tokyo (JP); Yusuke Nasu, Musashino-shi, Tokyo (JP)

(21) Appl. No.: 19/100,698

(22) PCT Filed: Aug. 5, 2022
(86) PCT No.: PCT/JP2022/030158

§ 371 Date: Feb. 3, 2025

(51) Int. Cl. G01L 1/24; H04B 10/079

(52) U.S. Cl. CPC G01L 1/24; H04B 10/07955

(57) ABSTRACT

Provided is a device for monitoring that realizes monitoring of an influence of thermal stress on a phase of an optical circuit on a surface where an optical circuit is formed. The device for monitoring according to the present disclosure is a device for monitoring for monitoring an influence of thermal stress on a phase of an optical circuit during mounting or actual operation on an optical module manufactured by a bare chip mounting method, wherein the device for monitoring includes a substrate and a plurality of stress sensitive circuits formed on the substrate, and wherein the device for monitoring is arranged on a surface of the optical module on which the optical circuit is formed, and monitors the influence of thermal stress on a phase of the optical circuit on the basis of either signal light propagating through the optical circuit or external light input from the outside.

### TECHNICAL FIELD

The present disclosure relates to a device for monitoring, and more particularly to a device for monitoring the influence of thermal stress on a phase of an optical circuit in an optical chip having the optical circuit.

### BACKGROUND ART

In the context of a rapid increase in communication demands, extensive studies on large-capacity communication networks are being carried on. Also, there is a strong demand for downsizing of optical modules that aims at increased bit rate and reduced power consumption per unit volume of communication equipment. Flip-chip mounting for mounting an optical chip on a substrate of an optical module in a face-down manner is one of the techniques meeting these demands.

Flip-chip mounting is one of bare chip mounting methods for directly bonding a chip of an element (semiconductor element or optical element) to a substrate of a module, and is a mounting method for directly bonding a chip having bumps to the substrate of the module in a face-down manner. Since flip-chip mounting can reduce a mounting area and a wiring length as compared with other bare chip mounting methods (for example, wire bonding mounting), the mounting method is suitable for mounting a small-sized module.

In flip-chip mounting having such a feature, since the substrate and the chip is directly bonded via the bumps, heating is inevitably required in the bonding process, and as a result, thermal stress caused by a difference in linear expansion coefficient between the substrate and the chip is generated on the whole surface of the chip and substrates and in the vicinity of the bonded portion. Further, since the chip manufactured by flip-chip mounting has a structure in which the substrate and the chip are directly bonded as described above, even when an apparatus generates heat, thermal stress can be generated on the whole surface of the chip and substrate and in the vicinity of the bonded portion.

In particular, in the case of an optical module manufactured by flip-chip mounting, it is known that such thermal stress affects the phase of the optical circuit in the actual operation, and therefore, the quality of the module is lowered. Therefore, it is important from the viewpoint of ensuring the performance of the optical module to appropriately monitor the influence of the thermal stress on the phase of the optical circuit during the mounting and the actual operation.

Conventionally, a method using a strain gauge has been applied as a method for monitoring the influence of such thermal stress on the phase of an optical circuit. More specifically, a strain gauge is attached to the rear surface of the substrate of the optical module (the substrate surface on the side where the optical circuit is not formed), and the strain that is output from a strain amplifier connected to the strain gauge is multiplied by the Young's modulus, to monitor the thermal stress (see, for example, NPL 1).

However, in this method, since the strain gauge is attached to the rear surface of the optical chip, it is impossible to accurately monitor the stress state of the surface where the optical circuit is formed. In addition, since stress measurement using a strain gauge can measure only stress in a limited region in the vicinity of the surface layer, the stress state inside the optical chip cannot be monitored. As described above, a monitoring method using a strain gauge, which is a conventional technique, has poor accuracy as a method for monitoring an influence on a phase of an optical circuit that thermal stress exerts, and therefore, the influence on the phase of the optical circuit cannot be accurately monitored.

### CITATION LIST

### Non Patent Literature

[NPL 1] Tsuneo Kumagai, “Strain gauge and bridge circuit,” Journal of the Society of Instrument and Control Engineers, Vol. 45, No. 4, pp. 323-328 (2006)

### SUMMARY OF INVENTION

The present disclosure has been made in view of the above-mentioned problems, and an object of the present disclosure is to provide a device for monitoring that realizes monitoring of the influence of thermal stress on a phase of an optical circuit on the surface where the optical circuit is formed.

In order to solve the above problems, the present disclosure provides a device for monitoring for monitoring an influence of thermal stress on a phase of an optical circuit during mounting or actual operation on an optical module manufactured by a bare chip mounting method, wherein the device for monitoring includes a substrate and a plurality of stress sensitive circuits formed on the substrate, is arranged on a surface of the optical module on which the optical circuit is formed, and monitors the influence of thermal stress on a phase of the optical circuit on the basis of either signal light propagating through the optical circuit or external light input from the outside.

### BRIEF DESCRIPTION OF DRAWINGS

FIG. 1 is a diagram conceptually showing a structure of a device for monitoring 10 according to a first embodiment of the present disclosure, wherein FIG. 1(a) is a perspective view of the entire device for monitoring 10, and FIG. 1(b) is a top view showing a stress sensitive circuit 12.

FIG. 2 is a diagram conceptually showing a structure of a device for monitoring 20 according to a second embodiment of the present disclosure, wherein FIG. 2(a) is a perspective view of the entire device for monitoring 20, and FIG. 2(b) is a top view showing a stress sensitive circuit 22.

FIG. 3 is a diagram conceptually showing a structure of a device for monitoring 30 according to the second embodiment of the present disclosure, wherein FIG. 3(a) is a perspective view of the entire device for monitoring 30, and FIG. 3(b) is a top view showing a stress sensitive circuit 32.

FIG. 4 is a diagram conceptually showing a structure of a device for monitoring 40 according to the second embodiment of the present disclosure, wherein FIG. 4(a) is a perspective view of the entire device for monitoring 40, and FIG. 4(b) is a top view showing a stress sensitive circuit 42.

### DESCRIPTION OF EMBODIMENTS

Various embodiments of the present disclosure are described hereinafter in detail with reference to the drawings. The same or similar reference numerals indicate the same or similar elements and redundant description thereof may be omitted. Materials and numerical values are intended for illustration and are not intended to limit the technical scope of the present disclosure. The following description can be implemented with some omissions or variations, or with additional configurations, as long as it does not depart from the gist of an embodiment of the present disclosure.

A device for monitoring according to the present disclosure is a chip device including a stress sensitive circuit installed on a substrate, and is characterized in monitoring the influence of thermal stress, which is generated during mounting or actual operation, on a phase of an optical circuit on the basis of changes in spectrum or power of light input to the stress sensitive circuit.

Furthermore, the device for monitoring according to the present disclosure can be installed on a surface where the optical circuit is formed, unlike a strain gauge according to the prior art. Therefore, the influence of thermal stress on the phase of the optical circuit can be monitored with higher accuracy than before.

In addition, the device for monitoring according to the present disclosure can be mounted by a bare chip mounting method as with a chip of an element forming an optical module. Therefore, there is an advantage that the conventional mounting process is not changed and the manufacturing cost and the prolongation of the process are not greatly affected.

It is to be noted that, in the present specification, the device for monitoring according to the present disclosure is described as being applied to an optical module manufactured by flip-chip mounting, but this is intended for illustration, and therefore the method of mounting the device for monitoring and the optical module is not limited to this. It should be noted that the device for monitoring according to the present disclosure is applicable to optical modules made by any bare chip mounting method.

### First Embodiment

A first embodiment of the device for monitoring according to the present disclosure is described hereinafter in detail with reference to the drawings. The device for monitoring according to the present embodiment relates to a configuration in which the stress sensitive circuit is an optical interferometer or a Ge photodiode, and the influence of thermal stress on the phase of the optical circuit is monitored on the basis of a change in light transmission spectrum or absorption spectrum.

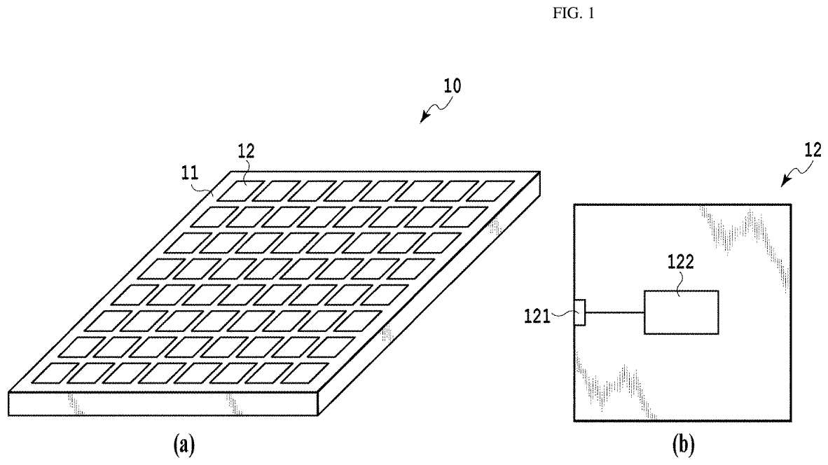

FIG. 1 is a diagram conceptually showing a structure of a device for monitoring 10 according to the first embodiment of the present disclosure, wherein FIG. 1(a) is a perspective view of the entire device for monitoring 10, and FIG. 1(b) is a top view showing a stress sensitive circuit 12. The device for monitoring 10 according to the present embodiment includes a substrate 11 and a plurality of stress sensitive circuits 12 arranged on the substrate 11. Further, the stress sensitive circuits 12 each include a port input 121 to which light to be monitored is input, and a detector 122 for detecting the light propagated from the input port 121. The detector 122 is connected to a measuring instrument (not shown) installed outside, and a signal output from the detector 122 is processed in the measuring instrument and displayed as a detection result.

In the device for monitoring 10 of the present embodiment having such a configuration, the detector 122 of the stress sensitive circuit 12 monitors the influence of thermal stress on a phase of the optical circuit on the optical circuit surface. The light may be an optical signal propagating through the optical module or light (external light) separately input from an external light source.

As an example, the detector 122 may be an optical interferometer such as a Mach-Zehnder interferometer, a ring resonator, a Michelson interferometer. In this case, the detector 122 outputs a light transmission spectrum, and the influence of thermal stress on the phase of the optical circuit is estimated from a change in transmission spectrum caused by the addition of the thermal stress.

As another example, the detector 122 may be a Ge photodiode. In this case, the detector 122 outputs an absorption spectrum of Ge, and the influence of thermal stress on the phase of the optical circuit is estimated from a change in absorption spectrum of Ge caused by the addition of thermal stress.

In this manner, the device for monitoring 10 according to the present embodiment enables monitoring of the influence of thermal stress on the phase of the optical circuit on the basis of the light propagated on the surface of the optical module where the optical circuit is formed. Therefore, the influence of thermal stress on the phase of the optical circuit can be monitored with high accuracy as compared with the conventional method of attaching a strain gauge to the rear surface.

Furthermore, in the device for monitoring 10 according to the present embodiment, the plurality of stress sensitive circuits 12 are provided on the substrate 11. By relatively evaluating the output from each stress sensitive circuit 12, the influence of thermal stress on the phase of the optical circuit can be monitored with high accuracy.

### Second Embodiment

A second embodiment of the present disclosure is described hereinafter in detail below with reference to the drawings. A device for monitoring according to the present embodiment relates to a configuration in which the stress sensitive circuit includes an optical interferometer having a phase adjustment mechanism, and the influence of thermal stress on the phase of the optical circuit is monitored on the basis of the amount of phase adjustment in the optical interferometer.

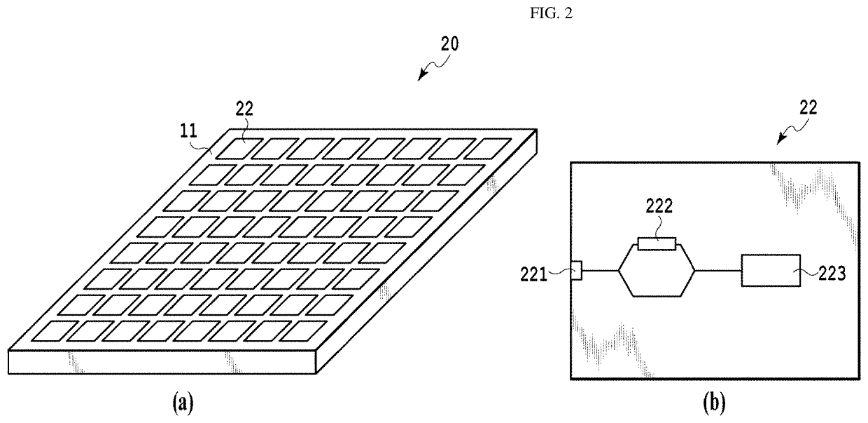

FIG. 2 is a diagram conceptually showing a structure of a device for monitoring 20 according to the second embodiment of the present disclosure, wherein FIG. 2(a) is a perspective view of the entire device for monitoring 20, and FIG. 2(b) is a top view showing a stress sensitive circuit 22. The device for monitoring 20 according to the present embodiment includes a substrate 11 and a plurality of stress sensitive circuits 22 arranged on the substrate 11. Further, the stress sensitive circuits 22 each include an input port 221 to which light to be monitored is input, a phase adjustment optical circuit 222 for adjusting a phase of the light propagated from the input port 221, a detector 223 for detecting the power of the light output from the phase adjustment optical circuit 222. The detector 223 is connected to a measuring instrument (not shown) installed outside, and a signal output from the detector 223 is processed in the measuring instrument and displayed as a result. The phase adjustment optical circuit 222 is configured to be able to adjust the phase of the input light in accordance with the output of the detector 223.

The phase adjustment optical circuit 222 may be, for example, a Mach-Zehnder interferometer having a phase adjustment mechanism. The detector 223 is, for example, a photodiode.

In the device for monitoring 20 configured as described above, in the stress sensitive circuit 22, the phase of light in the phase adjustment optical circuit 222 is adjusted so that the power of light output by the detector 223 becomes maximum. Application of thermal stress changes the amount of phase adjustment obtained when the power of the light becomes maximum. By measuring the amount of phase adjustment, the influence of the thermal stress on the phase of the optical circuit can be monitored.

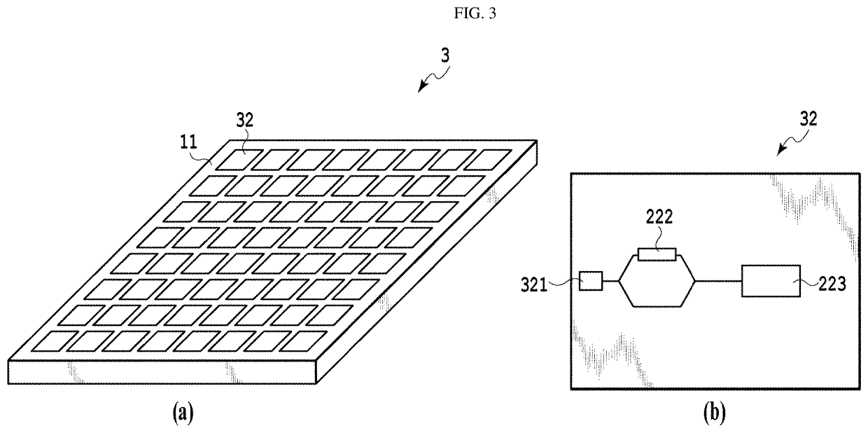

Also in the present embodiment as well, the light to be input may be signal light propagating through the optical module or external light separately input from an external light source. The light may be light having a single wavelength or may be ASE (Amplified Spontaneous Emission) light having a broad wavelength. An external light source 321 may be integrated in the stress sensitive circuit 32, as shown in FIG. 3. A device for monitoring 30 having such a configuration has an advantage that the monitoring can be performed more easily than the conventional technique because the process of inputting external light can be omitted.

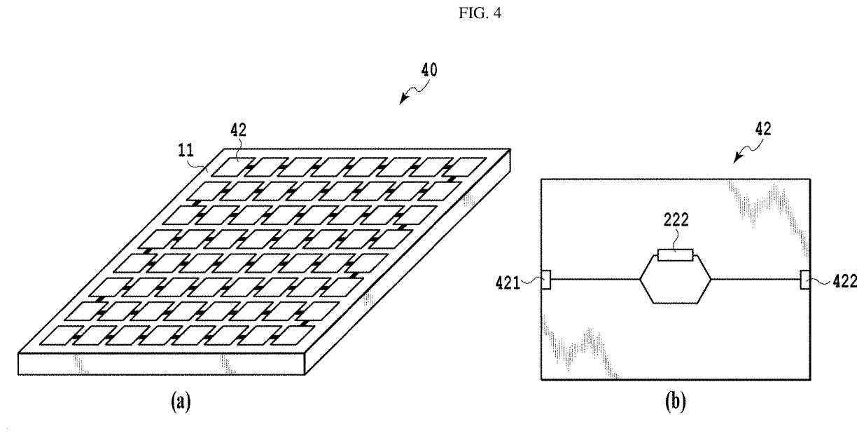

Further, in the present embodiment, as shown in FIG. 4, the plurality of stress sensitive circuits may be connected in series in a plane where the optical circuit of the optical module is formed. In a device for monitoring 40 shown in FIG. 4, an input port 421 of a stress sensitive circuit 42 is connected to an output port 422 of an adjacent stress sensitive circuit 42, and this connection is repeated to form a series of stress sensitive circuits 42 connected in series. The device for monitoring 40 having such a configuration can monitor the influence of thermal stress on the phase of the optical circuit with high accuracy even when the power of the input light is reduced.

In addition, in the above description, the resonance wavelength may be set in advance for each of the plurality of stress sensitive circuits so that the resonance wavelength varies. With such a configuration, by inputting the ASE light source or light having a wider width than the ASE light source, the resonance wavelength of each stress sensitive circuit can be monitored and controlled collectively by the optical spectrum, allowing for easy monitoring of the influence of thermal stress on the phase of the optical circuit.

### INDUSTRIAL APPLICABILITY

As described above, the device for monitoring according to the present disclosure makes it possible to monitor the influence of thermal stress on the phase of the optical circuit on the basis of the signal light or external light propagating through the surface of the optical module where the optical circuit is formed. Therefore, monitoring with higher accuracy than the prior art is possible, and it is expected that the device for monitoring according to the present disclosure is applied to an optical module as a device for monitoring quality.

1. A device for monitoring for monitoring an influence of thermal stress on a phase of an optical circuit during mounting or actual operation on an optical module manufactured by a bare chip mounting method, wherein the device for monitoring comprises:
a substrate; and
a plurality of stress sensitive circuits formed on the substrate, and wherein
the device for monitoring is arranged on a surface of the optical module that the optical circuit is formed, and monitors the influence of thermal stress on a phase of the optical circuit on the basis of either signal light propagating through the optical circuit or external light input from the outside.

2. The device for monitoring according to claim 1, wherein the stress sensitive circuits each also include an optical interferometer, and the device for monitoring monitors the influence of the thermal stress on the phase of the optical circuit on the basis of a change in light transmission spectrum output by the optical interferometer.

3. The device for monitoring according to claim 1, wherein the stress sensitive circuits each also include a Ge photodiode, and the device for monitoring monitors the influence of the thermal stress on the phase of the optical circuit on the basis of a change in absorption spectrum of Ge output by the Ge photodiode.

4. The device for monitoring according to claim 1, wherein the stress sensitive circuits each also include:
an optical input port that the signal light or the external light is input;
a phase adjustment optical circuit that adjusts a phase of the signal light or the external light input from the optical input port; and
a detector that detects power of the signal light or the external light output from the phase adjustment optical circuit, and wherein
the device for monitoring monitors the influence of the thermal stress on the phase of the optical circuit on the basis of an amount of phase adjustment in the phase adjustment optical circuit obtained when the power of the signal light or the external light detected by the detector becomes maximum.

5. The device for monitoring according to claim 4, wherein a light source of the external light is integrated on the substrate.

6. The device for monitoring according to claim 4, wherein the stress sensitive circuits are connected in series in a plane that the optical circuit is formed.

7. The device for monitoring according to claim 4, wherein resonance wavelengths of the respective stress sensitive circuits are set in advance so as to vary.
